(19) United States
(12) Patent Application Publication
(10) Pub. No.: US 2025/0158859 A1
(43) Pub. Date: May 15, 2025

(54) Method of embedding image information into radio frequency wave

(71) Applicants: Srdan Kovacevic, Osijek (HR); Anthony Cake, Geneva (CH); Daniel Hofman, Zagreb (HR); Boris Snajder, Zagreb (HR)

(72) Inventors: Srdan Kovacevic, Osijek (HR); Anthony Cake, Geneva (CH); Daniel Hofman, Zagreb (HR); Boris Snajder, Zagreb (HR)

(21) Appl. No.: 18/948,590

(22) Filed: Nov. 15, 2024

Related U.S. Application Data
(60) Provisional application No. 63/599,116, filed on Nov. 15, 2023.

(51) Int. Cl. H04L 27/26; H04N 7/045

(52) U.S. Cl. CPC H04L 27/2602; H04L 27/2628; H04L 27/265; H04N 7/045

(57) ABSTRACT

Instead of compressing and packetising video information before applying quadrature amplitude modulation (QAM) to encode data bits into orthogonal frequency division multiplexing (OFDM) symbols which are ultimately transmitted as radio frequency (RF) signal bursts, this invention uses pixel color intensity data (which is still digital), and a novel method of mapping digital video information into OFDM symbols based on a similar approach to classic QAM, to transmit video by avoiding compression and error correction, in order to receive and demodulate RF waveform in a way which is more noise-tolerant than traditional approaches.

### BACKGROUND OF THE INVENTION

Typical video transmission over a digital radio frequency (RF) link begins by converting pixel information of each frame into specific digital video data formats, and compressing this data to reduce the video stream size for transmission. The compressed data stream is segmented into data packets. Redundancy is introduced via error correction methods to attempt to mitigate errors at the receiving end. Video bitstream is then appropriately segmented in order to be modulated into In-phase Quadrature (IQ) symbols using the Quadrature Amplitude Modulation (QAM) technique. An Orthogonal Frequency-Division Multiplexing (OFDM) symbol is generated by Inverse Fast Fourier Transform (IFFT) from a set of IQ symbols; finally each OFDM symbol is then transmitted as an RF signal.

Reconstruction of the transmitted data at the receiving end is made difficult by the fact that the reception of RF signals is affected by inaccuracies in synchronization between the transmitter and the receiver, interference, and various sources of noise. As a result of these reception imperfections and noise, the reconstructed data stream will contain errors. If the number of errors in the reconstructed data stream is small enough, the error correction algorithm can correct them. However, usage of the error correction algorithm introduces significant overhead. Further, at low signal to noise ratio (SNR), the efficiency of error correcting algorithms significantly drops, leading to a reception of a digital data stream with errors.

If a data packet isn't reconstructed exactly, meaning that it contains errors, it's discarded (or “dropped”). A dropped packet can either be retransmitted, or the system may attempt to reconstruct the video stream without it, which can (and most often does) lead to visual information loss and a decrease in video quality.

A challenge in real-time digital RF video communication is the high sensitivity to image quality degradation due to packet drops. Even a 10% packet drop rate can severely affect video usability. Considering that a single misinterpreted data bit can result in a packet drop, live video streams transmitted over a digital RF link are highly sensitive to noise.

However, nowadays, the OFDM modulation technique is pervasive in terrestrial communication, being used in almost all standardized radio communication protocols, as it has proven to easily cope with various channel imperfections, notably multipath signal propagation.

Video transmission over an analog RF link begins by capturing visual information frame by frame. Unlike digital transmission, there is no conversion into digital data formats; the visual information remains in an analog format. The analog video signal is then modulated onto a carrier wave for transmission.

This modulated signal is transmitted over the RF link to the receiving end. Unlike digital transmission, there's no segmentation into data packets nor symbol modulation like QAM or OFDM. Color and brightness information of each pixel is modulated onto the continuous RF signal, and the spatial information (location of each pixel—or a “dot” in analog video—on the screen) is retained by the virtue of continuous sequential transmission of pixels (dots), line-by-line until the entire video frame is transmitted.

Upon reaching the receiving end, the modulated signal is demodulated to extract the original analog video signal. The video signal can then be displayed on a screen, reproducing the visual information (color and brightness) captured at the transmitting end.

An inherent challenge with analog video transmission is susceptibility to noise and interference, which can degrade the quality of the received video signal. Unlike digital transmission, there are no error correction methods to rectify inaccuracies, making the received video quality highly dependent on the transmission conditions. Further, resolution of analog video transmission is usually significantly lower than digital video transmission due to the fact that for the high resolution analog video transmission a wide RF channel would be required. Additionally, it is very difficult to compensate for channel imperfections using analog modulation techniques.

Any loss of signal strength or interference during transmission can result in a visible degradation of image quality. This degradation manifests as static or other artifacts on the screen. For instance, distortions of color or intensity, appearing as noise in the form of specks, are common artifacts in analog video. Additionally, RF signal reflections, where signals bounce off objects and create multiple paths to the receiver, can cause ghosting—duplicated images offset from the original. All those effects tend to rise in severity proportional to the RF channel bandwidth. However, even with those imperfections with analog video signal reception, human visual perception tends to cope with them better than with errors in compressed digital video.

The present invention, instead of compressing and packetising video frame information before applying QAM and OFDM to encode data bits into symbols and ultimately RF signal, utilizes “raw” pixel data (which is still digital), and a novel method of encoding pixel color intensity into the OFDM symbols, avoiding usage of the error correction methods, and accepting errors in reconstructed video data. Usage of the OFDM modulation technique provides a way to use a wide RF channel and a way to cope with channel imperfections, as well as transmitter-receiver synchronization, while acceptance of video data errors helps with human video quality perception in low SNR scenarios.

### SUMMARY OF THE INVENTION

An inherent challenge with analog video transmission is the susceptibility to noise and interference, which can degrade the quality of the received video signal. Unlike digital transmission, there are no error correction methods to rectify inaccuracies, making the received video quality highly dependent on the transmission conditions. Further, resolution of analog video transmission is usually significantly lower than digital video transmission due to the fact that for high resolution analog video transmission a wide RF channel is required. Additionally, it is very difficult to compensate for channel imperfections using analog modulation techniques.

At the receiving end, the transmitted data stream must be accurately reconstructed from the Radio Frequency (RF) signal. Accurate reconstruction of transmitted data is made difficult by the fact that reception of the RF signal is affected by inaccuracies in synchronization between the transmitter and the receiver, interference, and various sources of noise.

As a result of reception imperfections and noise, the reconstructed data stream will contain errors. If the number of errors in the reconstructed data stream is small enough, the error correction algorithm can correct them. However, usage of the error correction algorithm introduces significant overhead. Further, at a low signal to noise ratio (SNR), the efficiency of error correcting algorithms significantly drops, leading to a reception of a digital data stream with errors.

As opposed to compressing and packetising video frame information before applying QAM and OFDM to encode data bits into symbols, and ultimately RF signals, the present invention utilizes “raw” pixel data and a novel method of encoding pixel color intensity into OFDM symbols, avoiding the need for video encoding (compression) or usage of error correction methods, and accepting errors in reconstructed video data. As a result the present method increases human video quality perception in low SNR scenarios.

### BRIEF DESCRIPTION OF DRAWINGS

FIG. 1 Illustration of the principle of mapping of a pair of pixels from a grayscale image to a point on a 10×10 QAM constellation

FIG. 2 Process for creating OFDM symbols with pixel color information using the disclosure method

FIG. 3 OFDM Frame diagram with Frame Header and Frame data fields

FIG. 4 OFDM symbol in frequency and time domain with depiction of null, pilot, and video data subcarriers

FIG. 5 Transmitter processing unit

FIG. 6 Receiver processing unit

### DETAILED DESCRIPTION OF THE INVENTION

The method is a wireless transfer of video/image data using an OFDM modulation technique, with novel encoding of pixel values into OFDM subcarriers.

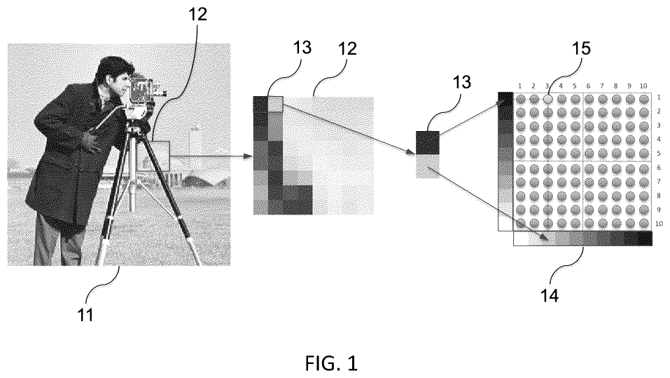

In the disclosure, instead of associating a unique binary combination with each point on a Quadrature Amplitude Modulation (QAM) constellation, the present method maps color intensity values of a pair of pixels into a point on a QAM constellation, where one pixel color value is mapped to in-phase value, and other pixel color value is mapped to quadrature-phase value, as illustrated in FIG. 1.

This enables transmission of information about the color intensity of two monochromatic pixels per symbol. In this way, each axis on the constellation represents a color gradient for each of the two pixels we are encoding into an In-phase Quadrature (IQ) symbol. A set of IQ symbols is then modulated into an Orthogonal Frequency-Division Multiplexing (OFDM) symbol by Inverse Fast Fourier Transform (IFFT).

FIG. 1 illustrates the principle of mapping of pixels to a QAM constellation. The figure shows a greyscale video frame (11), and a detail (12) from that same frame, where a pair of pixels (13) from the said detail (12) are mapped to a point (15) on an example of a QAM constellation (14) with 10 shades of gray.

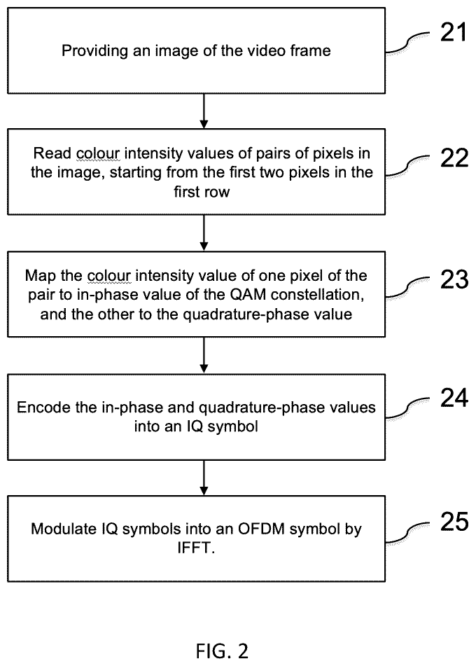

To transmit a monochromatic video, the present method relays each video frame by transmitting pairs of pixels as OFDM symbols in an ordered sequence, where OFDM symbols are created as described in FIG. 2.

To transmit a color video, the method relays each video frame in a similar fashion, but as an ordered sequence of color channel values of the pixels, with the values organized as tuples of symbols, where each symbol is an ordered pair of specific color channel values. The present method uses a specific encoding schema (association of specific color channels to symbols, and then organizing those symbols into tuples) that is devised for a specific color model, so that the receiving side can correctly reconstruct the image based on the sequence of received symbols.

In the method, a higher color depth requires higher complexity of the QAM constellation, for example: to transmit color depth with 16 shades for each channel, requires a scale of 16 levels per axis, meaning the method would utilize a 256-QAM constellation.

The advantage of the present method is in the way it handles RF noise and interference. Further, in signal reception, the present method accepts errors in an OFDM symbol (consequence of noise and interference), which effectively changes the reconstructed pixel intensity value. Reconstructing the image from pixel intensity values, however, leads to distortions being perceived by humans as static and individual pixel discoloration (similar to the distortions in analog video transmission).

Unlike analog video transmission methods, the present method allows the application of various correction and compensation techniques which are typically used to receive signals in a typical OFDM modulation process; the method is designed to apply these techniques before demodulating OFDM symbols which enables handling various channel imperfections which is not possible in analog video communication.

Upon completing the demodulation of the symbols, extraction of the pixel information, and reconstructing a frame, the method uses a variety of digital image processing methods (various forms of filtering etc.), based on the nature of human visual perception, in order to further neutralize the effects of noise and interference, which is something that cannot be as easily and efficiently implemented in an analog video transmission.

Consequently, the present invention results in an image where, despite loss of information, the perceived quality of the received image is still high as a result of the corrections employed.

### How the Method Works

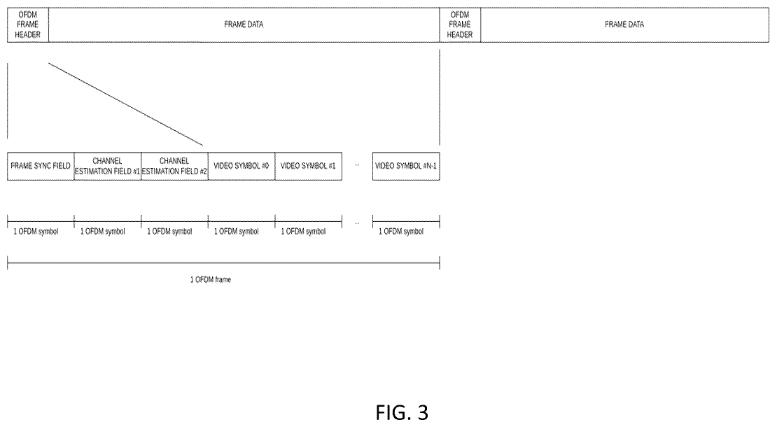

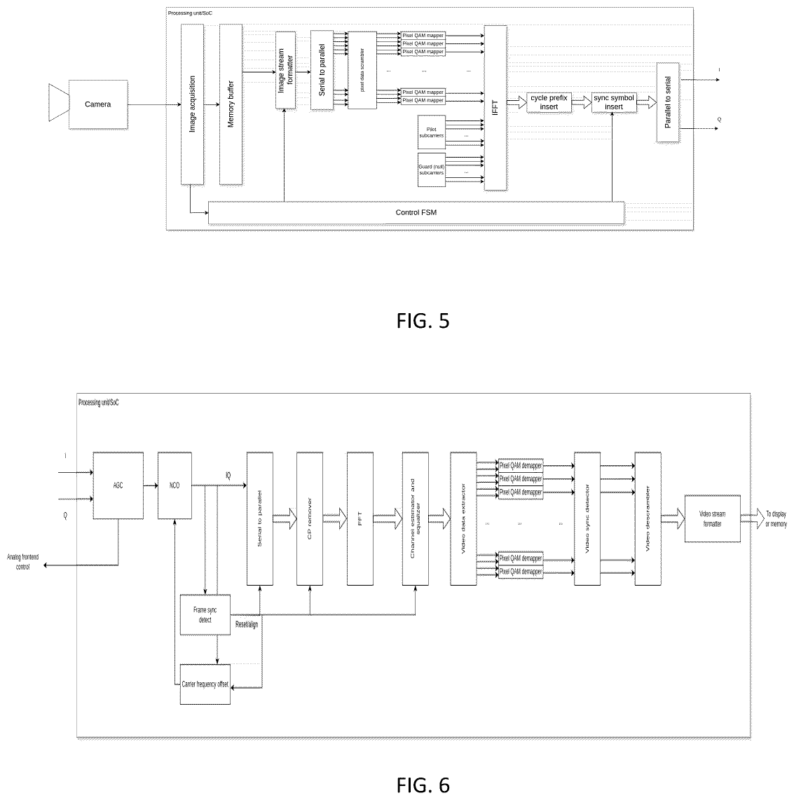

The transmitter component of the system (FIG. 5) receives a video stream that is encapsulated in OFDM frames, where each OFDM frame consists of the Frame Header and the Frame Data fields. FIG. 3

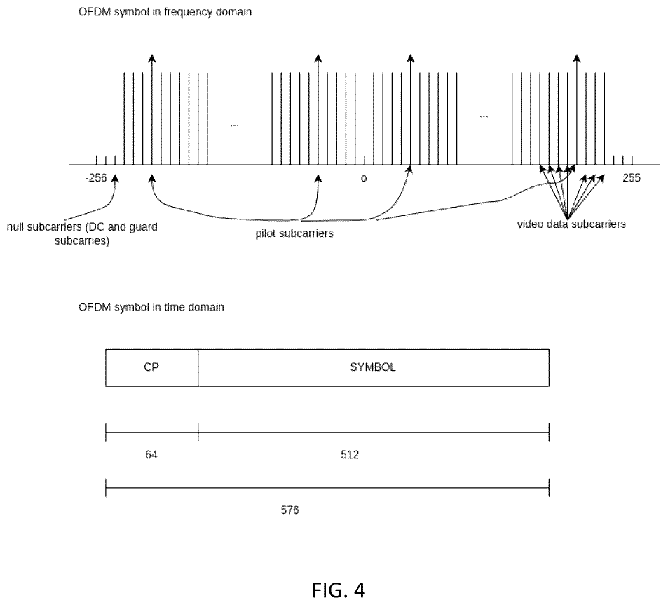

The video OFDM symbols are structured as shown in FIG. 4. In that example, 512 subcarries, with pilot spacing of 20 subcarriers are used. At the edge are inserted several guard subcarriers, that are zeros (not used). In the time domain, the OFDM symbol has 576 IQ samples (512 plus 64 samples for cycle prefix).

The channel estimation fields in the OFDM frame header have the same structure, except all subcarrier values are predefined and fixed, so the receiver can calculate channel estimation.

The frame sync symbol has repetitive null subcarriers in place of data subcarriers, to ensure repetitive structure in the time domain (that feature is used for low complex frame start detection). Each segment is m-sequence, which has nice cross-correlation properties.

A block diagram of the system that forms an IQ sample stream based on an image is depicted in FIG. 5.

The control Finite State Machine (FSM) monitors timing tracking (number of video OFDM symbols generated), detects image reception and performs other housekeeping tasks. Meanwhile, the transmitter and receiver define image resolution data.

The method was developed in such a way that radio communication link video throughput is slightly larger than input video requires (as a requirement to support different camera resolution in the same system, and to decouple camera clock frequency from the radio channel bandwidth).

To accommodate this difference in data rates, the image stream formatter will insert zeros as video data after retrieval of the whole video frame has been completed.

Further, when the Control FSM indicates the start of the new video frame, the image stream formatter will insert an array of pixels (twice the number of video data subcarriers in the one video OFDM symbol), as a result a special OFDM video symbol will be formed in front of the valid video stream.

When the Control FSM indicates the start of the new video frame, the image stream formatter will insert an array of pixels (twice the number of video data subcarriers in the one video OFDM symbol), as a result a special OFDM video symbol will be formed in front of the valid video stream.

This special video OFDM symbol marks the beginning of a new video frame. The output of the image stream formatter is fed into a serial to parallel converter that provides the value of a few pixels for each video data subcarrier. The values of those pixels are then scrambled to provide randomization.

The pixel data scrambler input and output have the same format. The output of the pixel data scrambler goes into an array which takes a few pixels and provides one QAM symbol (one QAM symbol for each video data subcarrier).

Next, pixel QAM symbols, pilot subcarriers, and guard subcarriers are fed into an Inverse Fast Fourier Transform (IFFT), which forms the basis of the OFDM symbol.

A cycle prefix is then added to the output of the IFFT, and the quadrature signals (IQ) stream is ready to transfer. The control FSM instructs insert block when to insert header symbols, and when to pass video OFDM symbols. FIG. 6

The Pixel QAM mapper equation of the method can be stated as (if, for example, the pixel value is uint_8 format, meaning it can take any value between 0 to 255):

$$PixQAM = {\sum }_{i = 0}^{N / 2 - 1} ( ( P i x V a l ( i ) / 128 - 1 ) + j * ( P i x V a l ( i + 1 ) / 128 - 1 ) ) ,$$

$$where j = \sqrt{- 1}$$

Accordingly, if PixVal is uint_8 format (byte), then the PixQAM will effectively be QAM-65536.

The receiver block diagram is depicted in FIG. 6. The receiver performs signal processing through a frame sync detection block that continuously tracks IQ streams, and identifies the FRAME SYNC FIELD.

When the FRAME SYNC FIELD is detected, the reset/align signal is asserted. The reset/align signal aligns other blocks to OFDM symbol boundaries.

This process is primarily used to remove the cycle prefix, but also to indicate that the following OFDM symbols will be CHANNEL ESTIMATION symbols. Thus, when the reset signal is received, the CP remover block resets its counter, and the FFT block will be purged; finally, both the channel estimation as well as the equalizer block will be ready for processing.

In addition, the channel estimator uses pilot tones to continuously track channel state, and adapts the channel equalizer accordingly.

The video data extractor takes data from the video data subcarriers and feeds it into the system enabling the Pixel QAM demapping. Then the method searches for a video sync symbol.

At the start of a video frame, the pixel data is received into the descrambler, and descrambled data can then either be stored in memory or displayed.

To conclude, the method uses regular OFDM processes for synchronization and channel state tracking and equalization. The difference is that we take values of a couple of pixels, map them to the amplitudes of in-phase and quadrature components, giving a rise to a QAM-655536 constellation.

In any realistic scenario that kind of signal cannot be received without error in a typical digital communication link however the method treats components as pixel intensity, tolerates errors (i.e. does not try to fix them), and instead transmits all values as received to be displayed as we have received them.

1. A method for embedding image information into radio frequency wave, comprising the steps of:
receiving a video image frame;
modulating video image information into the radio frequency signal, demodulating the radio frequency signal containing the image information, and receiving each radio frequency signal burst;
applying Orthogonal Frequency Division Multiplexing (OFDM) techniques to correct for interference;
processing intensity values of pairs of pixels beginning with the first two pixels in the first row to reconstruct pixel information from information extracted from the corrected radio frequency signal;
mapping the color intensity value of one pixel of the pair to the inphase value of the quadrature amplitude modulation constellation and the other to the quadrature phase value to display both noise and information;
applying spatial and temporal filtering and averaging techniques to neutralize certain effects of noise;
encoding the in phase and quadrature phase values into an In-phase Quadrature (IQ) symbol;
utilizing a robust data channel to transport, and retain the integrity of, certain meta-data to improve the informational retrieval performance of the post-processing, and;
modulating IQ symbols into an OFDM symbol using an Inverse Fast Fourier Transform (IFFT).

2. A computer implemented system for embedding image information into radio frequency wave, comprising:
a circuit for receiving image information and modulating video image information into radio frequency, demodulating the RF signal containing the image information and receiving each radio frequency signal burst, correcting for interference using Orthogonal Frequency Division Multiplexing;
means for processing intensity values to reconstruct intensity values extracted from the corrected radio frequency signal, mapping the intensity value to display both noise and image information, applying spatial and temporal filtering and averaging techniques to neutralize certain effects of noise, encoding the in phase and quadrature phase values into an In-phase Quadrature (IQ) symbol; and
a robust data channel to transport, and retain the integrity of, certain meta-data to improve the informational retrieval performance of the post-processing and modulate IQ symbols into an OFDM symbol using an Inverse Fast Fourier Transform (IFFT).
